(19) United States
(12) Patent Application Publication
(10) Pub. No.: US 2021/0001173 A1
(43) Pub. Date: Jan. 7, 2021

(54) RUNNER MATCHING APPLICATION, RUNNER MATCHING DEVICE INCLUDING THE SAME, AND RUNNER MATCHING METHOD USING THE SAME

(71) Applicant: Jong Hwa LEE, Seongnam-si (KR)

(72) Inventor: Jong Hwa LEE, Seongnam-si (KR)

(21) Appl. No.: 16/654,660

(22) Filed: Oct. 16, 2019

(30) Foreign Application Priority Data
Jul. 5, 2019 (KR) 10-2019-0081276

(51) Int. Cl. A63B 24/00

(52) U.S. Cl. CPC A63B 24/0062; A63B 24/0075; A63B 2220/73; A63B 2220/12; A63B 2220/75; A63B 2024/0068; A63B 2220/72

(57) ABSTRACT

Provided is a runner matching device may include a running environment collecting unit configured to acquire reference running environment information related to a running environment including at least one of an air quality, an altitude, a temperature, and a humidity of a running route of a specific runner, a matching runner selection receiving unit configured to receive, from the specific runner, a request for selection of a matching runner who is to have a running match with the specific runner, and a runner matching unit configured to, when a request for runner matching is made to the matching runner selection receiving unit, provide the matching runner, wherein the matching runner has a running environment that is in accordance with the reference running environment information.

### CROSS-REFERENCE TO RELATED APPLICATIONS

This application claims the priority of the Korean Patent Applications NO 10-2019-0081276 filed on Jul. 5, 2019, in the Korean Intellectual Property Office, the disclosure of which is incorporated herein by reference.

### BACKGROUND OF THE INVENTION

### 1. Field of the Invention

The present invention relates to a runner matching application, a runner matching device including the same, and a runner matching method using the same, and more particularly to a runner matching application, in which a running environment and a preference of a specific runner are considered, a runner matching device including the same, and a runner matching method using the same.

### 2. Description of the Prior Art

In recent years, various technologies which associate exercises and electronic device have been developed. Through the association of the exercises and the electronic devices, the users can manage exercise records.

Running together may be more advantageous that running alone in an aspect of interests of exercises, but there is a difficulty in adjusting running schedules of a plurality of runners.

In addition, because most the existing electronic devices interworking with exercises only manage personal exercise records of user, there is a limit in matching exercise matches of users at different times and in different spaces or managing the related exercise records.

Accordingly, an exercise matching device or an exercise matching method, by which restrictions on environments and time and spaces in which a plurality of runners can be minimized and the exercise environments and the preferences of the users are considered, has been required.

### SUMMARY OF THE INVENTION

One technical problem which is to be solved by the present invention is to provide a runner matching application, in which a running environment and a preference of a specific runner are considered in selecting a matching runner who is to run together with the specific runner, a runner matching device including the same, and a runner matching method using the same.

One technical problem which is to be solved by the present invention is to provide a runner matching application, in which temporal and spatial restrictions are minimized in a running match of a specific runner and a matching runner, a runner matching device including the same, and a runner matching method using the same.

One technical problem which is to be solved by the present invention is to provide a runner matching application, which provides a fair running match of a specific runner and a matching runner, a runner matching device including the same, and a runner matching method using the same.

The objectives of the present invention are not limited to the above-described ones.

In order to solve the technical objects, the present invention provides a runner matching device.

According to an embodiment, a runner matching device may include a running environment collecting unit configured to acquire reference running environment information related to a running environment including at least one of an air quality, an altitude, a temperature, and a humidity of a running route of a specific runner, a matching runner selection receiving unit configured to receive, from the specific runner, a request for selection of a matching runner who is to have a running match with the specific runner, and a runner matching unit configured to, when a request for runner matching is made to the matching runner selection receiving unit, provide the matching runner, wherein the matching runner has a running environment that is in accordance with the reference running environment information.

According to an embodiment, when providing the matching runner, the matching runner may belong to a city or a nation that is different from that of the specific runner.

According to an embodiment, the matching runner selection receiving unit may receive the selection of the matching runner from the specific runner, and may receive the selection of the matching runner who is to run together in real time or receive the selection of the matching runner, whose record is to be compared with that of the specific runner in non-real time, and the runner matching unit may provide the matching runner who is in accordance with the real-time or non-real-time selection of the matching runner, which is requested from the matching runner selection receiving unit.

According to an embodiment, the request for the selection of the matching runner may be made to the matching runner selection receiving unit by the specific runner, and the matching runner selection receiving unit may receive information on a distance for running, and the runner matching unit may provide, to the matching runner selection receiving unit, the matching runner who is in accordance with the received distance for the running.

According to an embodiment, the request for the selection of the matching runner may be made to the matching runner selection receiving unit by the specific runner, and the matching runner selection receiving unit may receive information on a course for running, and the runner matching unit may provide, to the matching runner selection receiving unit, the matching runner who is in accordance with the received course for the running.

According to an embodiment, the runner matching device may further include a record managing unit configured to manage a running record of the specific runner, and the runner matching unit may provide a matching runner who is in accordance with the running record of the specific runner in providing the matching runner.

According to an embodiment, the record managing unit may further manage records for running sections of the specific runner, the request for the selection of the matching runner may be made to the matching runner selection receiving unit, and a request for, among the running sections, a specific running section for finding the corresponding matching runner may be made to the matching runner selection receiving unit, and the runner matching unit may provide, to the matching runner selection receiving unit, the matching runner who is in accordance with the record of the specific runner in the specific running section.

According to an embodiment, the runner matching device may further include a running broadcasting unit configured to broadcast a running situation of the specific runner and the matching runner, the running broadcasting unit may broadcast the running situation to the specific runner in real time.

According to an embodiment, the runner matching device may further include a record managing unit, the record managing unit may manage a section, in which the running ranks of the specific runner and the matching runner are changed, as a highlight section, and the record managing unit may provide contents on the broadcasting of the running broadcasting unit in the highlight section.

According to an embodiment, the request for the selection of the matching runner may be made to the matching runner selection receiving unit by the specific runner, and a request for the number of matching runners may be made to the matching runner selection receiving unit, and the runner matching unit may provide the matching runner based on the number of the matching runners.

In order to solve the technical objects, the present invention provides a runner matching method.

According to an embodiment, a runner matching method may include receiving, from the specific runner, a request for selection of a matching runner who is to have a running match with the specific runner, acquiring reference running environment information related to a running environment including at least one of an air quality, an altitude, a temperature, and a humidity of a running route of a specific runner, and providing the matching runner, wherein the matching runner has a running environment that is in accordance with the reference running environment information.

According to an embodiment, the receiving of the request for the selection of the matching runner may include receiving a request for at least one of the matching runner who is to runner together with the specific runner in real time or whose record is to be compared with that of the specific runner in non-real time, a distance, by which the specific runner is to run, a running record of the specific runner, and the number of participants whom the specific runner desires to run with.

According to an embodiment, the runner matching method may further include managing records for running sections of the specific runner, and the receiving of the request for the selection of the matching runner further may include receiving a request for, among the running sections provided in the managing of the records for the running sections, a specific running section for finding the corresponding matching runner is made to the matching runner selection receiving unit.

According to an embodiment, the runner matching method may further include broadcasting a running situation of the specific runner and the matching runner in real time.

According to an embodiment, the runner matching method may further include providing a section, in which the running ranks of the specific runner and the matching runner are changed, as a highlight section.

In order to solve the technical objects, the present invention provides a runner matching application.

According to an embodiment, there is provided a runner matching application stored in a medium to execute operations of receiving, from the specific runner, a request for selection of a matching runner who is to have a running match with the specific runner, acquiring reference running environment information related to a running environment including at least one of an air quality, an altitude, a temperature, and a humidity of a running route of a specific runner, and providing the matching runner, wherein the matching runner has a running environment that is in accordance with the reference running environment information.

Accordingly, because a matching runner who is to have a running match with a specific runner after a request for at least one of the matching runner who is to runner together with the specific runner in real time or whose record is to be compared with that of the specific runner in non-real time, a distance and a course, by which the specific runner is to run, a specific running section, and the number of matching runners is received, the preference of the specific runner can be enhanced.

Further, a running match, in which minimized temporal and spatial restrictions are applied to the specific runner and the matching runner, may be provided through the specific runner matching device and the matching device of the matching runner which communicate with each other through a server.

Further, because a matching runner having a running environment that is in accordance with the reference running environment information related to the running environment including at least one of the air quality, the altitude, the temperature, and the humidity of the running route of the specific runner is provided, a fair and motivated running match may be provided to the specific runner and the matching runner.

Further, because the running record of the specific runner is managed and the section in which the running ranks of the specific runner and the matching runner are changed is managed as a highlight section if the running match of the specific runner and the matching runner is ended, the running ability of the specific runner can be improved.

### BRIEF DESCRIPTION OF THE DRAWINGS

The above and other objects, features, and advantages of the present invention will be more apparent from the following detailed description taken in conjunction with the accompanying drawings, in which:

FIG. 1 and FIG. 2 are views illustrating a runner matching device according to an embodiment of the present invention;

FIG. 3 is a view of a request for runner matching according to the embodiment of the present invention;

FIG. 4 is a view illustrating a running environment collecting unit according to the embodiment of the present invention;

FIG. 5, FIG. 6, FIG. 7, FIG. 8 and FIG. 9 are views illustrating a matching runner selection receiving unit according to the embodiment of the present invention;

FIG. 10, FIG. 11, FIG. 12, FIG. 13, FIG. 14, FIG. 15 and FIG. 16 are views illustrating a runner matching unit according to the embodiment of the present invention;

FIG. 17 is a view illustrating a running broadcasting unit according to the embodiment of the present invention;

FIG. 18 and FIG. 19 are views illustrating a record managing unit according to the embodiment of the present invention; and

FIG. 20 is a flowchart of a runner matching method according to an embodiment of the present invention.

### DETAILED DESCRIPTION OF THE EXEMPLARY EMBODIMENTS

Hereinafter, preferred embodiments of the present invention will be described in detail with reference to the accompanying drawings. However, the technical spirit of the present invention is not limited to the embodiments, but may be realized in different forms. The embodiments introduced here are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the shapes and the thicknesses of the areas are exaggerated for efficient description of the technical contents.

Further, in the various embodiments of the present invention, the terms such as first, second, and third are used to describe various elements, but the elements are not limited to the teams. The terms are used only to distinguish one element from another element. Accordingly, an element mentioned as a first element in one embodiment may be mentioned as a second element in another embodiment. The embodiments illustrated here include their complementary embodiments. Further, the term “and/or” in the specification is used to include at least one of the elements enumerated in the specification.

In the specification, the terms of a singular form may include plural foils unless otherwise specified. Further, the terms “including” and “having” are used to designate that the features, the numbers, the steps, the elements, or combination thereof described in the specification are present, and may be understood that one or more other features, numbers, step, elements, or combinations thereof may be added. Further, in the specification, “connected to” is used to mean a plurality of elements are indirectly or directly connected to each other.

Further, in the following description of the present invention, a detailed description of known functions and configurations incorporated herein will be omitted when it may make the subject matter of the present invention unnecessarily unclear.

Hereinafter, a runner matching device and a runner matching method according to embodiments of the present invention will be described.

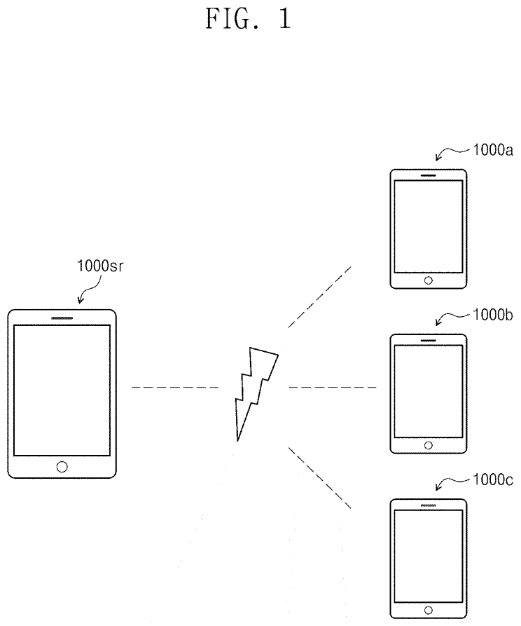

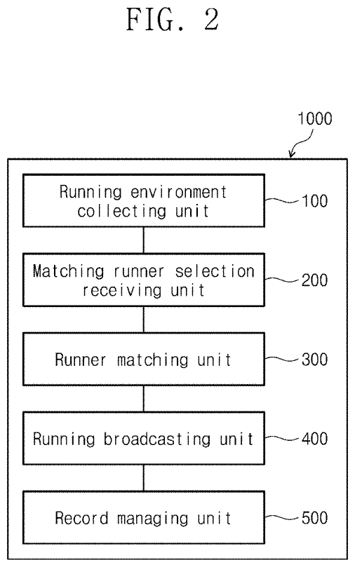

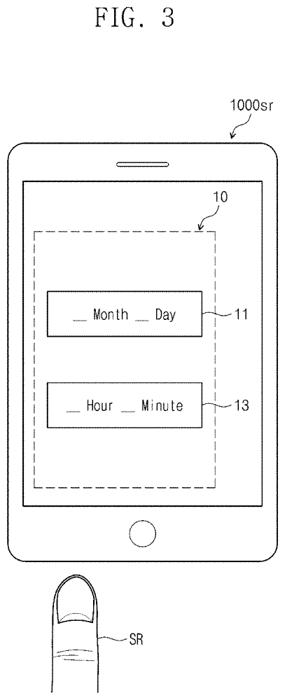

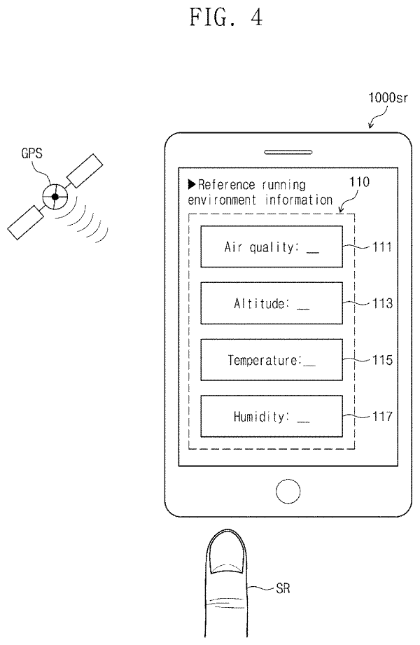

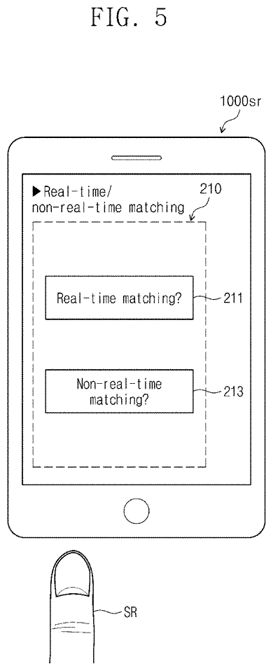

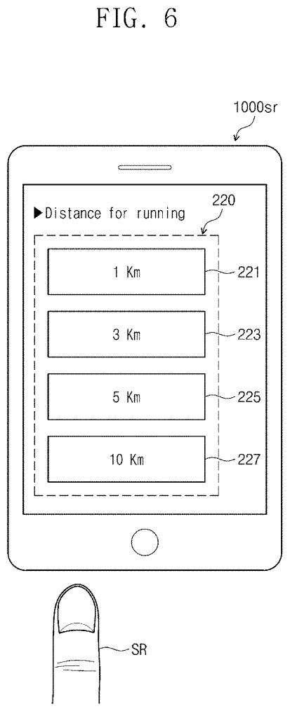

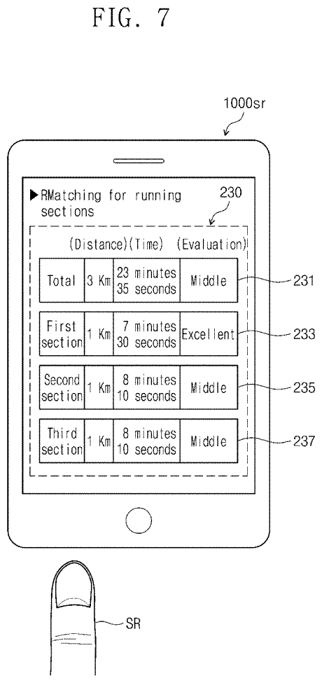

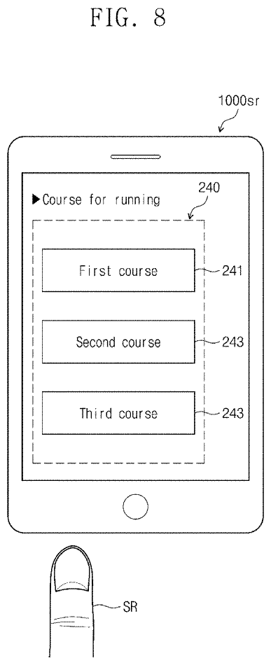

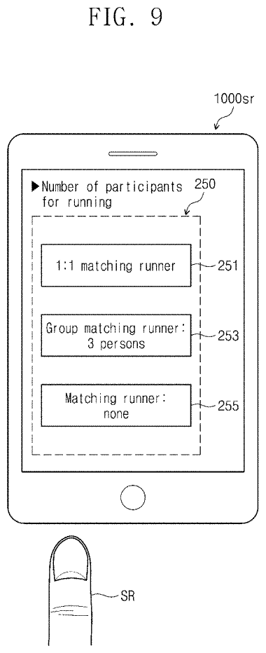

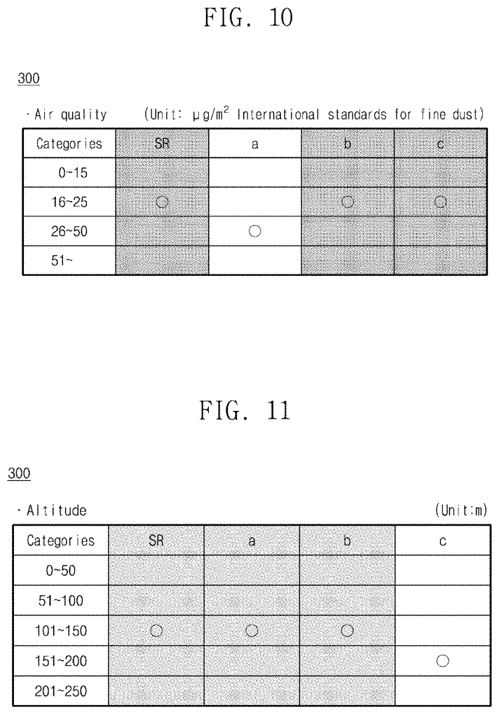

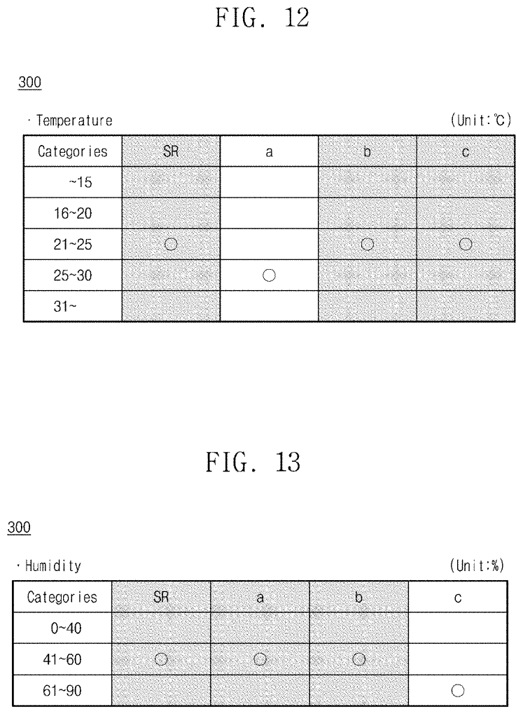

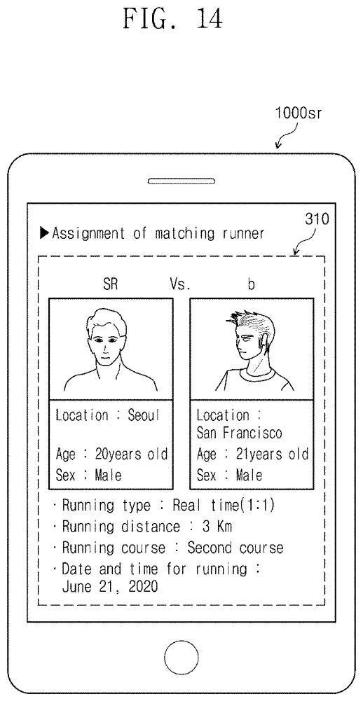

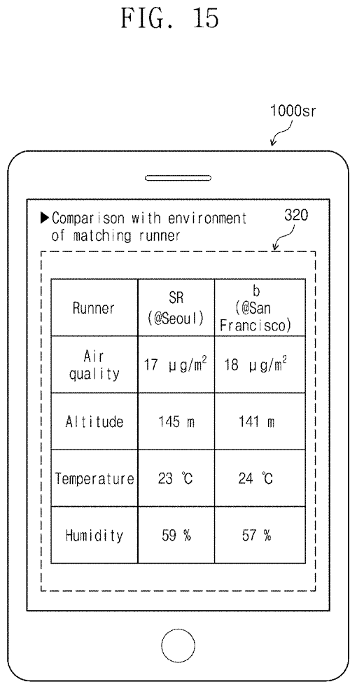

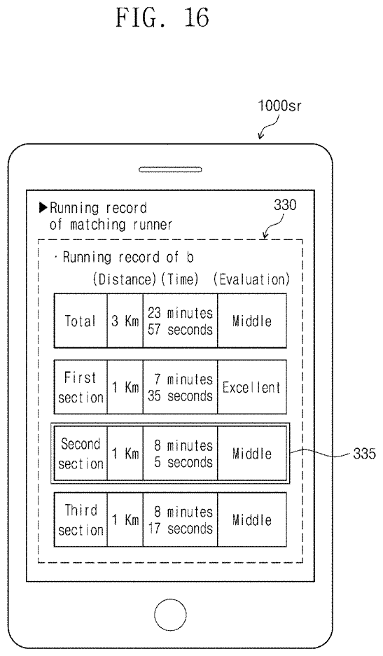

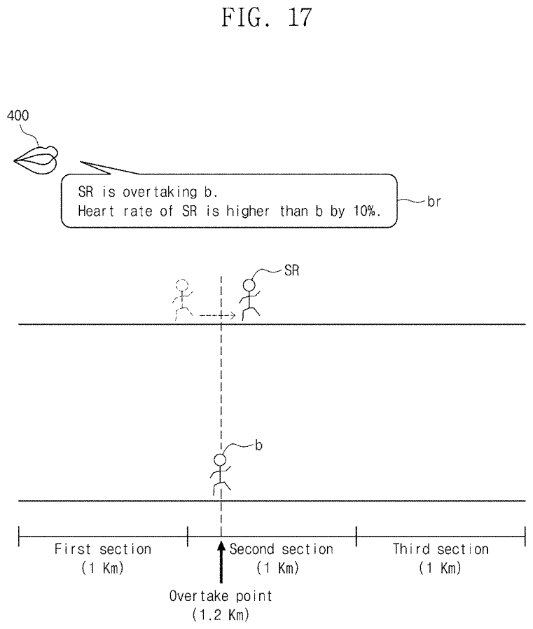

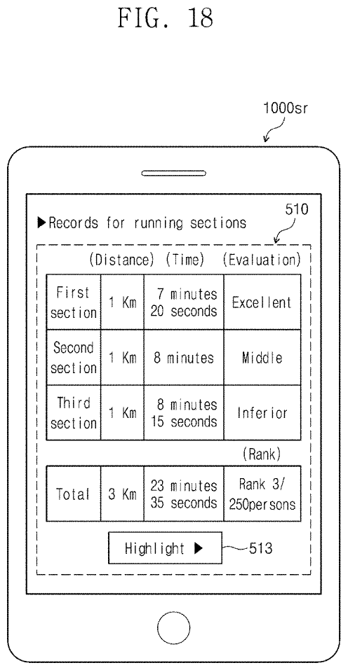

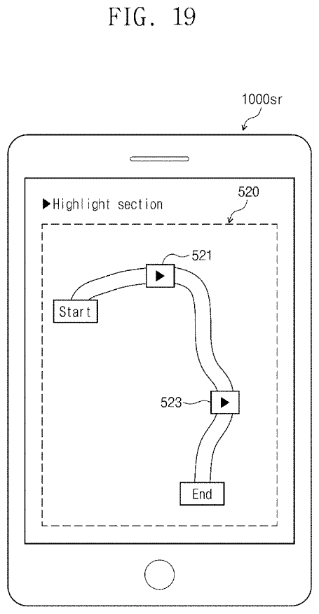

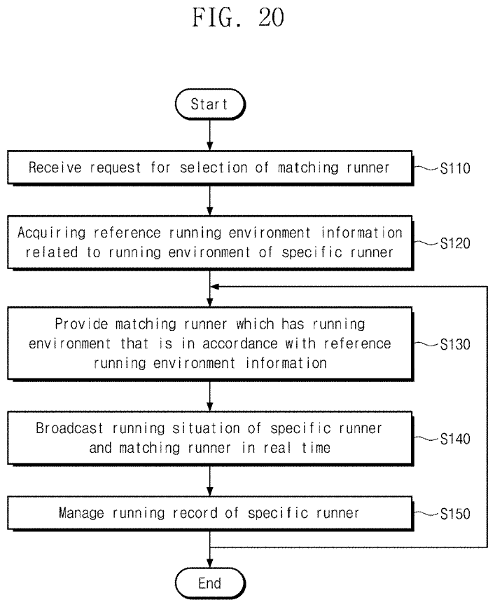

FIGS. 1 and 2 are views illustrating a runner matching device according to an embodiment of the present invention. FIG. 3 is a view of a request for runner matching according to the embodiment of the present invention. FIG. 4 is a view illustrating a running environment collecting unit according to the embodiment of the present invention. FIGS. 5 to 9 are views illustrating a matching runner selection receiving unit according to the embodiment of the present invention. FIGS. 10 to 16 are views illustrating a runner matching unit according to the embodiment of the present invention. FIG. 17 is a view illustrating a running broadcasting unit according to the embodiment of the present invention. FIGS. 18 and 19 are views illustrating a runner managing unit according to the embodiment of the present invention. FIG. 20 is a flowchart of a runner matching method according to an embodiment of the present invention.

The runner matching device 1000 according to the embodiment of the present invention may select, among a plurality of unspecific runners a, b, and c, a matching runner who are in accordance with a request of a specific runner SR and may provide the matching runner to a specific runner who desires to have a running match.

That is, the runner matching device 1000 may match an optimum runner as a running counterpart of the specific runner SR.

In more detail, referring to FIG. 1, the runner matching device 1000, that is, a matching device 1000sr of the specific runner, and at least one of matching devices 1000a, 1000b, and 1000c of a plurality of unspecific matching runners, who are to have a running match with the specific runner, may be prepared for the specific runner SR and at least one of the plurality of unspecific matching runners a, b, and c.

Here, the plurality of unspecific matching runners a, b, and c may mean candidate matching runners that are to be matching runners.

The matching device 1000sr of the specific runner and at least one of the matching devices 1000a, 1000b, and 1000c of the plurality of unspecific matching runners may share necessary information through a server.

That is, the matching device 1000sr of the specific runner may, when receiving, from the specific runner SR, a request for selection of a matching runner who is to have a running match with the specific runner SR, communicate with at least one of the matching devices 1000a, 1000b, and 1000c of the plurality of specific matching runners through the server, and may select, among the plurality of unspecific runners a, b, and c, a matching runner who is in accordance with the request of the specific runner SR.

In detail, the matching device 1000sr of the specific runner and at least one of the matching devices 1000a, 1000b, and 1000c of the plurality of unspecific matching runners may minimize temporal and spatial restrictions, and may match the specific runner SR and a matching runner, among the plurality of unspecific runners a, b, and c.

According to the embodiment, the runner matching device 1000 may cause the specific runner SR and the matching runner, among the plurality of unspecific runners a, b, and c to have a running match in real time.

That is, the matching device 1000sr of the specific runner may, while matching a specific runner SR in a first city of a first nation, for example, in Seoul of Korea, who accesses the server through the matching device 1000sr of the specific runner and a matching runner b in a second city of a second nation, for example, in San Francisco, who accesses the server through the matching device 1000b of the matching runner while minimizing the spatial restriction of nations, cause the specific runner SR and the matching runner b to have a running match.

According to the embodiment, the runner matching device 1000 may cause the specific runner SR and the matching runner, among the plurality of unspecific runners a, b, and c to have a running match by using the records thereof.

That is, if the specific runner SR accesses the server through the matching device 1000sr of the specific runner for a running match, the matching device 1000sr of the specific runner may selectively download, the records of the plurality of unspecific matching runners a, b, and c, a matching record desired by the specific runner SR even in a state in which the plurality of unspecific matching runners a, b, and c do not access the server.

Accordingly, the matching device 1000sr of the specific runner may cause the specific runner SR and the plurality of unspecific matching runners a, b, and c to have a running match by using the matching records while minimizing temporal restrictions.

That is, the matching device 1000sr of the specific runner and the runner matching devices including the matching devices 1000a, 1000b, and 1000c of the plurality of unspecific matching runners may minimize temporal and spatial restrictions, and may match the specific runner SR and a matching runner of the plurality of specific runners a, b, and c.

In addition, the runner matching device 1000 may broadcast running situations of the specific runner SR and the matching runner, and may manage the running records.

To achieve this, referring to FIG. 2, the runner matching device 1000 may include at least one of a running environment collecting unit 100, a matching runner selection receiving unit 200, a runner matching unit 300, a running broadcasting unit 400, and a record managing unit 500.

According to an embodiment, the runner matching device 1000 may acquire reference running environment information related to a running environment of the running route of the specific runner SR, through the running environment collecting unit 100.

Further, the runner matching device 1000 may receive a request for selection of a matching runner who is to have a running match with the specific runner SR from the specific runner SR, through the matching runner selection receiving unit 200.

The runner matching device 1000 may, when the matching runner selection receiving unit 200 receives a request for runner matching, provide a matching runner having a running environment that is in accordance with the reference running environment information to the specific runner SR.

The runner matching device 1000 may, when the specific runner SR and the matching runner have a running match, broadcast the running situations of the specific runner SR and the matching runner, through the running broadcasting unit 400.

The runner matching device 1000 may, when the running of the specific runner SR and the matching runner is ended, manage the running record of the specific runner SR, through the record managing unit 500.

Hereinafter, the configurations of the runner matching device 100, that is, the matching device 1000sr provided to the specific runner SR will be described in detail.

Further, although a situation in which the specific runner SR and the matching runner are matched in one-to-one correspondence will be described in an embodiment, which will be described below, it is apparent that the specific runner SR and a plurality of matching runners who are in accordance with the request for the matching of the specific runner SR may be matched in one-to-multiple correspondence.

Referring to FIG. 3, the matching runner selection receiving unit 200 may receive a request for a running matching with the matching runner, from the specific runner SR.

In detail, the matching runner selection receiving unit 200 may provide “Date (Month Day)” and “Time (Hour Minute)”, at which a running match is to be made, to the specific runner SR through the runner matching request screen 10 as “Date (Month Day)” and “Time (Hour Minute)” are input by touching a “Date (Month Day)” input button 11 and a “Time (Hour Minute)” input button 13.

Accordingly, the matching runner selection receiving unit 200 may acquire information on a running match, which is input by the specific runner SR, in detail, a data and a time.

The running environment collecting unit 100 may acquire reference running environment information related to the running environment of the specific runner SR.

To achieve this, according to the embodiment, the running environment collecting unit 100, as illustrated in FIG. 4, may provide a screen 110 for acquiring the reference running environment information to the specific runner SR. That is, the running environment collecting unit 100 may provide, to the specific runner SR, the screen 110 for acquiring the reference running environment information including at least one of an air quality, an altitude, a temperature, and a humidity of the running route of the specific runner SR.

In detail, the running environment collecting unit 100, as illustrated in FIG. 4, may provide an air quality, an altitude, a temperature, and a humidity of the running route of the specific runner SR to the specific runner SR, through the reference running environment information screen 110 as the air quality, the altitude, the temperature, and the humidity of the running route of the specific runner SR are input by touching at least one of an “air quality” input button 111, an “altitude” input button 113, a “temperature” input button 115, and a “humidity” input button 117 of the running route of the specific runner SR.

Accordingly, the specific runner SR may input various items of the reference running environment information by touching the buttons 111 to 117 provided by the running environment collecting unit 100, through the reference running environment information screen 110.

Accordingly, the running environment collecting unit 100 may acquire the reference running environment information input by the specific runner SR, in detail, information including at least one of the air quality, the altitude, the temperature, and the humidity of the running route of the specific runner SR.

Further, according to another embodiment, the running environment collecting unit 100, as illustrated in FIG. 4, may acquire the reference running environment information from a global positioning system (GPS).

In detail, the running environment collecting unit 100 may, when the specific runner SR maintains a state in which the matching device 1000sr of the specific runner SR is connected to the GPS, acquire the reference running environment information including at least one of the air quality, the altitude, the temperature, and the humidity of the running route of the specific runner SR, on the basis of the location of the specific runner SR, through the GPS.

In this case, unlike the above-described embodiment, the running environment collecting unit 100 may acquire the reference running environment information that has not been input by the specific runner SR. That is, the specific runner SR does not need to input the reference running environment information by pressing the buttons 111 to 117 on the screen 110 for acquiring the reference running environment information.

However, even in this case, the running environment collecting unit 100, as illustrated in FIG. 4, may provide an air quality, an altitude, a temperature, and a humidity of the running route of the specific runner SR to the specific runner SR, through the reference running environment information screen 110 as the air quality, the altitude, the temperature, and the humidity of the running route of the specific runner SR are input by touching at least one of an “air quality” input button 111, an “altitude” input button 113, a “temperature” input button 115, and a “humidity” input button 117 of the running route of the specific runner SR.

Accordingly, the specific runner SR may, when the running environment collecting unit 100 determines that the reference running environment information acquired from the GPS is inaccurate, correct the reference running environment information determined to be inaccurate and inputting the corrected reference running environment information.

The matching runner selection receiving unit 200 may receive a request for selection of a matching runner who is to have a running match with the specific runner SR from the specific runner SR.

In more detail, the matching runner selection receiving unit 200 may receive the selection of the matching runner from the specific runner SR, and receives the selection of the matching runner who is to run together in real time or may receive the selection of the matching runner, whose record is to be compared with that of the specific runner SR in non-real time.

To achieve this, the matching runner selection receiving unit 200, as illustrated in FIG. 5, may provide a screen 210 for acquiring information on the real-time or non-real-time matching to the specific runner SR.

In detail, the matching runner selection receiving unit 200, as illustrated in FIG. 5, may provide any one of the texts of “real-time matching?” and “non-real-time matching?” to the specific runner SR through the screen 210 for acquiring information on the real-time or non-real-time matching as any one of the texts of “real-time matching?” and “non-real-time matching?” is selected by touching any one of a “real-time matching?” selection button 211, which is used for selecting a matching runner who is to run together with the specific runner SR in real time and a “non-real-time matching?” selection button 213, which is used for selecting a matching runner whose record is to be compared with that of the specific runner SR in non-real time.

Accordingly, the specific runner SR may select the real-time or non-real-time matching by touching any one of the buttons 211 and 213 provided by the matching runner selection receiving unit 200, through the screen 210 for acquiring the information on the real-time or non-real-time matching.

Accordingly, the matching runner selection receiving unit 200 may acquire the information on the real-time or non-real-time matching selected by the specific runner SR.

Further, the matching runner selection receiving unit 200 may receive a request for selection of a matching runner from the specific runner SR, and may receive information on the distance for running.

To achieve this, the matching runner selection receiving unit 200, as illustrated in FIG. 6, may provide a screen 220 for acquiring information on the distance for running to the specific runner SR.

For example, the matching runner selection receiving unit 200, as illustrated in FIG. 6, may provide any one of the distances for running of “1 Km”, “3 Km”, “5 Km”, and “10 Km” to the specific runner SR, through the screen 200 for acquiring information on the distances for running as one of the distances of “1 Km”, “3 Km”, “5 Km”, and “10 Km” is selected by touching one of a “1 Km” selection button 221, a “3 Km” selection button 223, a “5 Km” selection button 225, and a “10 Km” selection button 227.

Accordingly, the specific runner SR may select the distance for running by touching any one of the buttons 221 to 227 provided by the matching runner selection receiving unit 200, through the screen 210 for acquiring the information on the distance for running.

Accordingly, the matching runner selection receiving unit 200 may acquire the information on the distance for running selected by the specific runner SR.

Further, the matching runner selection receiving unit 200 may receive a request for, among the running sections, a specific running section for finding the corresponding matching runner, from the specific runner SR.

To achieve this, the matching runner selection receiving unit 200, as illustrated in FIG. 7, may provide a screen 220 for acquiring information on matching for the running sections, to the specific runner SR.

In detail, the matching runner selection receiving unit 200 may provide the past running records of the specific runner SR through the screen 230 for acquiring information of matching for the running sections. For example, the matching runner selection receiving unit 200, as illustrated in FIG. 7, may provide, among the past running records of the specific runner SR, a total record, a record for the first section, a record for the second section, and a record for the third section, through a screen 230 for acquiring information on the matching for the running sections.

Then, the information on the total record, the record for the first section, the record for the second section, and the record for the third section may be selected by touching a “total” record selection button 231, a record for the “first section” selection button 233, a record for the “second section” selection button 235, and a record for the “third section” selection button 237.

Accordingly, the specific runner SR may select the running section for finding a matching runner by touching any one of the buttons 231 to 237 provided by the matching runner selection receiving unit 200, through the screen 230 for acquiring the information on the matching for the running sections.

Accordingly, the matching runner selection receiving unit 200 may acquire the information on the running section selected by the specific runner SR.

Accordingly, the specific runner SR may find a matching runner, who is to run with, among a person having a total record that is similar to that of the specific runner SR, a person having a similar record for the first section, a person having a similar record for the second section, and a person having a similar record for the third section.

Further, the matching runner selection receiving unit 200 may receive information on the running course from the specific runner SR.

To achieve this, the matching runner selection receiving unit 200 may output a map screen, and may, when the specific runner SR drags a specific route of the map screen by a hand, receive the dragged route as a route for running. In this case, the running environment receiving unit 100 may acquire a running environment of the dragged route according to a schedule for running.

Unlike this, the matching runner selection receiving unit 200, as illustrated in FIG. 8, may provide a screen 240 for acquiring information on the course for running to the specific runner SR.

For example, the matching runner selection receiving unit 200, as illustrated in FIG. 8, may provide any one of the courses for running of a “first course”, a “second course”, and a “third course” to the specific runner SR, through the screen 240 for acquiring information on the courses for running as one of the courses of the “first course”, the “second course”, and the “third course” is selected by touching one of a “first course” selection button 241, a “second course” selection button 243, and a “third course” selection button 245.

Then, the matching runner selection receiving unit 200 may, when the buttons 241 to 245 illustrated in FIG. 8 are touched, provide map screen corresponding to the courses (that is, the first to third courses) on the screen 240 for acquiring information on the running courses.

In detail, the information on the running route may include at least one of information on the altitude, the distance, and the contour of the running course selected by the specific runner SR.

Accordingly, the specific runner SR may select the course for running by touching any one of the buttons 241 to 245 provided by the matching runner selection receiving unit 200, through the screen 240 for acquiring the information on the course for running.

In addition, the matching runner selection receiving unit 200 may acquire running route information on at least one of the altitude, the distance, and the contour of the running course.

Further, the matching runner selection receiving unit 200 may receive information on the number of matching runners who are to participate in running, that is, the number of participants for the running, from the specific runner SR.

To achieve this, the matching runner selection receiving unit 200, as illustrated in FIG. 9, may provide a screen 250 for acquiring information on the number of the participants for the running to the specific runner SR.

For example, as illustrated in FIG. 9, the matching runner selection receiving unit 200 may provide any one of the texts of “1:1 matching runner”, “Group matching runner: 3 persons”, and “No matching runner: None” to the specific runner SR as any one of the texts of “1:1 matching runner”, “Group matching runner: 3 persons”, and “No matching runner: None” is selected by touching a “1:1 matching runner” selection button 251 when the number of participants for running is one, touching a “Group matching runner: 3 persons” selection button 253 when the number of participants for running is plural (for example, three), and a “No matching runner: None” selection button 255 when the number of participants for running is zero.

Accordingly, the specific runner SR may select the number of participants for running by touching any one of the buttons 251 to 255 provided by the matching runner selection receiving unit 200, through the screen 250 for acquiring the information on the number of participants for running.

Accordingly, the matching runner selection receiving unit 200 may acquire the information on the number of participants for running selected by the specific runner SR.

The runner matching unit 300 may, when the matching runner selection receiving unit 200 receives a request for the runner matching from the specific runner SR, provide a matching runner having a running environment that is in accordance with the reference running environment information.

First, the runner matching unit 300 may, when the matching runner selection receiving unit 200 receives a request for the runner matching from the specific runner SR, acquire the reference running environment information on the running route of the specific runner SR acquired by the running environment collecting unit 100.

In detail, referring to FIG. 10, the runner matching unit 300 may acquire information on the air quality among the reference running environment information on the running route of the specific runner SR, which has been acquired by the running environment collecting unit 100.

For example, the air quality of the running route of the specific runner SR acquired by the running environment collecting unit 100 may be in a range of 16 to 25 μg/m². Further, the air quality of the running route of candidate matching runner a may be in a rate of 26 to 50 μg/m², and the air qualities of the running routes of candidate matching runners b and c may be in a range of 16 to 25 μg/m².

Accordingly, the runner matching unit 300 may acquire all information on the range of the air quality of the running route of the specific runner SR of 16 to 25 μg/m², the range of the air quality of the running route of candidate matching runner a of 26 to 50 μg/m², and the range of the air quality of the running route of candidate matching runners b and c of 16 to 25 μg/m², which have been acquired by the running environment collecting unit 100, and may match the acquired range of the air quality of the running route of the specific runner SR and the ranges of the air qualities of candidate matching runners a to c.

Accordingly, the runner matching unit 300 may select, as a candidate matching runner, candidate matching runners b and c who are in accordance with the range of the air quality of the running route of the specific runner SR of 16 to 25 μm/m2.

Further, referring to FIG. 11, the runner matching unit 300 may acquire information on the altitude among the reference running environment information on the running route of the specific runner SR, which has been acquired by the running environment collecting unit 100.

For example, the altitude of the running route of the specific runner SR acquired by the running environment collecting unit 100 may be in a range of 101 to 150 m. Further, the altitude of the running route of candidate matching runners a and b may be in a range of 101 to 150 m, and the altitude of the running route of candidate matching runner c may be in a range of 151 to 200 m.

Accordingly, the runner matching unit 300 may acquire all information on the range of the altitude of the running route of the specific runner SR of 101 to 150 m, the range of the altitude of the running route of candidate matching runners a and b of 101 to 150 m, and the range of the altitude of the running route of candidate matching runner c of 151 to 200 m, which have been acquired by the running environment collecting unit 100, and may match the acquired range of the altitude of the running route of the specific runner SR and the ranges of the altitudes of candidate matching runners a to c.

Accordingly, the runner matching unit 300 may select, as a candidate matching runner, candidate matching runners a and b who are in accordance with the range of the altitude of the running route of the specific runner SR of 101 to 150 m.

Further, referring to FIG. 12, the runner matching unit 300 may acquire information on the temperature among the reference running environment information on the running route of the specific runner SR, which has been acquired by the running environment collecting unit 100.

For example, the temperature of the running route of the specific runner SR acquired by the running environment collecting unit 100 may be in a range of 21 to 25° C. Further, the temperature of the running route of candidate matching runner a may be in a range of 25 to 30° C., and the temperature of the running route of candidate matching runners b and c may be in a range of 21 to 25° C.

Accordingly, the runner matching unit 300 may acquire all information on the range of the temperature of the running route of the specific runner SR of 21 to 25° C., the range of the temperature of the running route of candidate matching runner a of 25 to 30° C., and the range of the temperature of the running route of candidate matching runners b and c of 21 to 25° C., which have been acquired by the running environment collecting unit 100, and may match the acquired range of the temperature of the running route of the specific runner SR and the ranges of the temperatures of candidate matching runners a to c.

Accordingly, the runner matching unit 300 may select, as a candidate matching runner, candidate matching runners b and c who are in accordance with the range of the temperature of the running route of the specific runner SR of 21 to 25° C.

Further, referring to FIG. 13, the runner matching unit 300 may acquire information on the humidity among the reference running environment information on the running route of the specific runner SR, which has been acquired by the running environment collecting unit 100.

For example, the humidity of the running route of the specific runner SR acquired by the running environment collecting unit 100 may be in a range of 41 to 60%. Further, the humidity of the running route of candidate matching runners a and b may be in a range of 41 to 60%, and the humidity of the running route of candidate matching runner c may be in a range of 61 to 90%.

Accordingly, the runner matching unit 300 may acquire all information on the range of the humidity of the running route of the specific runner SR of 41 to 60%, the range of the humidity of the running route of candidate matching runners a and b of 41 to 60%, and the range of the humidity of the running route of candidate matching runner c of 61 to 90%, which have been acquired by the running environment collecting unit 100, and may match the acquired range of the humidity of the running route of the specific runner SR and the ranges of the humidity of candidate matching runners a to c.

Accordingly, the runner matching unit 300 may select, as a candidate matching runner, candidate matching runners a and b who are in accordance with the range of the humidity of the running route of the specific runner SR of 41 to 60%.

The runner matching unit 300 may, with reference to FIGS. 10 to 13, consider all of candidate matching runners b and c matched with the air quality of the running route of the specific runner SR, candidate matching runners a and b matched with the altitude of the running route of the specific runner SR, candidate matching runners b and c matched with the temperature of the running route of the specific runner SR, and candidate matching runners a and b matched with the humidity of the running route of the specific runner SR.

Accordingly, the runner matching unit 300 may finally determine that the environment information of candidate matching runner b is in accordance with the reference running environment information of the specific runner SR.

Accordingly, as illustrated in FIG. 14, the runner matching unit 300 may compare the profiles including at least one of the locations, the ages, and the sexes of the finally determined candidate matching runner b and the specific runner SR, and may provide the result through the matching runner assigning screen 310.

In addition, the runner matching unit 300 may provide, on the matching runner assigning screen 310, the real-time or non-real-time running matching selected by the specific runner SR through the screen 210 for acquiring the information on the real-time or non-real-time matching of the matching runner selection receiving unit 200 described with reference to FIG. 5, the number of participants selected by the specific runner SR through the screen 250 for acquiring the information on the number of running participants of the matching runner selection receiving unit 200 described with reference to FIG. 9, the distance for running selected by the specific runner SR through the screen 220 for acquiring the information on the distance for running of the matching runner selection receiving unit 200 described with reference to FIG. 6, the course for running selected by the specific runner SR through the screen 240 for acquiring the information on the course for running of the matching runner selection receiving unit 200 described with reference to FIG. 8, and the date and time input by the specific runner SR through the screen 10 for acquiring the information on the date and time of the matching runner selection receiving unit 200 described with reference to FIG. 3.

That is, the runner matching unit 300 may select candidate matching runner b who is in accordance with the reference running environment information of the specific runner SR, and may provide, through the matching runner assigning screen 310, a running type, a running distance, a running course, and a running date/time including the information on the real-time or non-real-time matching and the number of running participants in addition to the profile of candidate matching runner b.

Meanwhile, according to an example, the runner matching unit 300 may, when the specific runner SR requests real-time matching, identify, also from the matching runner, whether the matching runner desires to run together with the specific runner SR in selecting the matching runner. Then, it is apparent that the identification may be made through a user interface. Unlike this, the runner matching unit 300 may, when the specific runner SR requests non-real-time matching, may omit identification of the matching runner because the specific runner SR competes with the record of the matching runner.

The runner matching unit 300 may, if the matching runner who is to have a running match with the specific runner SR is selected, provide a screen 320 for comparing the reference running environment information and the environment of the matching runner to the specific runner SR.

Accordingly, the specific runner SR can consider the environment of candidate matching runner b which is matched with the air quality, the altitude, the temperature, and the humidity of the running route of the specific runner SR, which have been described with reference to FIGS. 10 to 13.

According to the embodiment, the runner matching unit 300 may, when the matching runner selection receiving unit 200 described with reference to FIG. 7 requests, from the records of the running sections of the specific runner SR, a specific running section for searching for a matching runner, as illustrated in FIG. 16, provide a matching runner who is in accordance with the record of the specific runner SR in the specific running section.

For example, when the matching runner selection receiving unit 200 of FIG. 7 requests the runner matching unit 300 of FIG. 16 to search for a matching runner for the record of the second section 235 among the running sections of the specific runner SR, the runner matching unit 300 may provide matching runner b who holds the record of the second section 335, that is, distance: 1 Km, time: 8 minutes 05 seconds, and evaluation: medium, which is in accordance with the record of the second section 235 of the specific runner SR, that is, distance: 1 Km, time: 8 minutes 10 seconds, and evaluation: medium.

The running broadcasting unit 400 may, if the runner matching unit 300 selects matching runner b who is to having a running match with the specific runner SR and the running match of the specific runner SR and the matching runner b starts, broadcast the running situation of the specific runner SR and the matching runner b.

In more detail, the running broadcasting unit 400 may broadcast, the specific runner SR, the running situation of the specific runner SR and the matching runner b in real time.

Referring to FIG. 17 a situation of a 1:1 running match of the specific runner SR and the matching runner b will be described as an example.

As illustrated in FIG. 17, in a situation in which the specific runner SR overtakes matching runner b at a point of 0.2 Km at which the specific runner SR enters the second section via the first section, the running broadcasting unit 400 may broadcast (br), to the specific runner SR, that “The specific runner SR is overtaking matching runner b. The heart rate of the specific runner SR is higher than that of matching runner b by 10%.” through the matching device 1000sr of the specific runner SR.

Meanwhile, in the above-described situation in which the specific runner SR overtakes matching runner b at a point of 0.2 Km at which the specific runner SR enters the second section via the first section, the running broadcasting unit 400 may broadcast (br), to matching runner b that “Matching runner b is overtaken by the specific runner SR. The heart rate of matching runner b is lower than that of the specific runner SR by 10%.” through the matching device 1000b of matching runner b.

Further, the running broadcasting unit 400 may, during a running match of the specific runner SR and matching runner b, analyze the running situation of the specific runner SR and matching runner b, and may give an advice to the specific runner SR or matching runner b.

In detail, for example, in a situation in which the current running speed of the specific runner SR becomes lower than the initial running speed, the running broadcasting unit 400 may broadcast, to the specific runner SR or matching runner B that “The name of the specific runner SR, for example, runner Jack, Be careful about the tendency of a rapid declination of the pace after the speed-up at the beginning.”, to the specific runner SR through the matching device 1000sr of the specific runner or to matching runner b through the matching device 1000b of matching runner b.

Further, as another example, in a situation in which the specific runner SR renews the running record, the running broadcasting unit 400 may broadcast that “Jack, You can renew the record if you maintain the current speed.” to the specific runner SR through the matching device 1000sr of the specific runner SR.

Further, as another example, in a situation in which the running distances of the specific runner SR and matching runner b are different by a predetermined distance during the running match, the running broadcasting unit 400 may broadcast that “You are passing by the intermediate point of the current race. The distance difference between Jack or the name of matching runner b, for example, John is about 200 m, to the specific runner SR through the matching device 1000sr of the specific runner SR. Further, the running broadcasting unit 400 may broadcast, through the matching device 1000b of matching runner b, that “You are passing by the intermediate point of the current race. John, the distance difference from Jack is about 200 m.”.

Further, as another example, in a situation in which the specific runner SR overtakes matching runner b, the running broadcasting unit 400 may broadcast that “Jack, John's speed is decreasing. You can overtake John if you speed up a little further” to the specific runner SR through the matching device 1000sr of the specific runner SR.

Further, the running broadcasting unit 400 may, during the running match of the specific runner SR and matching runner b, broadcast overall contents related to the match situation of the specific runner SR and matching runner b. For example, the speeds, the distance difference, the covered running distances, and the covered running times of the runners may be broadcasted.

The record managing unit 500 may, if the running match of the specific runner SR and matching runner b is ended, manage the running record of the specific runner SR.

In detail, referring to FIG. 18, the record managing unit 500 may manage the records for the running sections and the total section of the specific runner SR. That is, the record managing unit 500 may record the first to third sections in which the specific runner SR has run and the total section, and may provide the records to the specific runner SR through the record screen 510 for the running sections.

Accordingly, the specific runner SR may consider his or her record, and in the following match, as described with reference to FIG. 7, may request a specific running section for finding a matching runner from the records for the running sections, from the matching runner selection receiving unit 200. When the specific runner SR requests a specific running section for finding a matching runner from the records for the running sections of the specific runner SR, from the matching runner selection receiving unit 200, as described with reference to FIG. 16, the runner matching unit 300 may provide a matching runner who is in accordance with the record of the specific runner SR in the specific running section.

Further, the record managing unit 500 may manage a section, in which the running ranks of the specific runner SR and matching runner b are changed, as a highlight section. In detail, as illustrated in FIG. 18, the highlight button 513 may be provided to the specific runner SR through the record screens 510 for the running sections.

If the specific runner SR touches the highlight button 513, as illustrated in FIG. 19, the record managing unit 500 may provide a screen 520 displaying the highlight section to the specific runner SR.

Accordingly, the specific runner SR may touch a play button 521 on the screen 520 displaying the highlight section to acquire information on the highlight section in which the specific runner SR overtakes matching runner b and the running ranks are changed.

In more detail, when the specific runner SR touches the play button 521 to identify the highlight section to be identified, the record managing unit 500 may provide contents on the broadcasting of the running broadcasting unit 400 in the highlight section.

For example, when the specific runner SR is to identify the broadcasting of the overtaking point described with reference to FIG. 17, the specific runner SR may touch the play button 521 on the overtaking point, and the record managing unit 500 may provide the broadcasting contents on the overtaking point to the specific runner SR. Here, the contents may be understood as a comprehensive concept including audios, maps, and videos. Further, provision of the broadcasting contents may be understood as a comprehensive concept including downloading and real-time streaming of all or some of the contents.

Further, the record managing unit 500 may provide information on the sections in which main situations occur during the running match in addition to a section, in which the running ranks of the specific runner SR and matching runner b are changed, as a highlight section. In detail, the record managing unit 500 may provide the highlight button 513 to the specific runner SR.

If the specific runner SR touches the highlight button 513, the record managing unit 500 may provide a screen 520 displaying the highlight section to the runner SR.

Accordingly, the specific runner SR may touch the play button 523 on the screen 520 displaying the highlight section to acquire information on the sections in which the main situations occurred during the running match. In detail, for example, the specific runner SR may touch the play button 523 to acquire information including information on arrival at the initial, middle, and latter parts of the match, a situation before 100 m from a goal point, a situation of the section of a speed-up, a situation in which the runners repeatedly overtake each other, the distance difference and the speed difference between the counterparts, and renewal of a new record. Then, it is apparent that the specific runner SR may be provided with the overall contents related to the match situation as contents.

Until now, the runner matching device 1000 according to the embodiment of the present invention has been described.

According to the embodiment of the present invention, the runner matching device 1000 may include at least one of a running environment collecting unit 100, a matching runner selection receiving unit 200, a runner matching unit 300, a running broadcasting unit 400, and a record managing unit 500.

Accordingly, a runner matching method using the runner matching device 1000, as illustrated in FIG. 20, may include a step S110 of receiving of the request for the selection of the matching runner from a specific runner SR, a step S120 of acquiring reference running environment information related to a running environment of the specific runner SR, a step S130 of providing the matching runner, wherein the matching runner has a running environment that is in accordance with the reference running environment information, a step S140 of broadcasting a running situation of the specific runner SR and the matching runner in real time, and a step S150 of managing a running record of the specific runner SR.

In step S110, selection of the matching runner may be received from the specific runner SR. In more detail, the matching runner selection receiving unit 200 may receive a request for selection of a matching runner who is to have a running match with the specific runner SR from the specific runner SR, from the specific runner SR.

In step S120, reference running environment information related to a running environment of the specific runner SR may be acquired. In more detail, when the matching runner selection receiving unit 200 receives a request for the running match, the running environment collecting unit 100 may acquire the reference running environment information related to the running environment including at least one of the air quality, the altitude, the temperature, and the humidity of the running route of the specific runner SR.

Further, the matching runner selection receiving unit 200 may receive a request for selection of a matching runner who is to have a running match with the specific runner SR from the specific runner SR, from the specific runner SR.

Further, the matching runner selection receiving unit 200 may receive a request for at least one of the matching runner who is to runner together with the specific runner in real time or whose record is to be compared with that of the specific runner in non-real time, a distance and a course, by which the specific runner is to run, a specific running section, and the number of matching runners.

In step S130, a matching runner, wherein the matching runner has a running environment that is in accordance with the reference running environment information may be provided. In more detail, the runner matching unit 300 may, when the matching runner selection receiving unit 200 receives a request for the runner matching, provide a matching runner having a running environment that is in accordance with the reference running environment information to the specific runner SR.

In step S140, a running situation of the specific runner SR and the matching runner in real time may be broadcasted. In detail, when the specific runner SR and the matching runner have a running match, the running broadcasting unit 400 may broadcast the running situations of the specific runner SR and the matching runner in real time.

In step S150, a running record of the specific runner SR may be managed. In more detail, the record managing unit 500 may, if the running match of the specific runner SR and the matching runner is ended, manage the running record of the specific runner SR. Further, the record managing unit 500 may manage a section, in which the running ranks of the specific runner SR and the matching runner are changed, as a highlight section, and may provide contents on the broadcasting of the running broadcasting unit in the highlight section.

According to the embodiment of the present invention, the running record of the specific runner SR in step S150 may be provided after step S120 again. Accordingly, in step S130, the runner matching unit 300 may provide, to the specific runner SR, a matching runner in which the running record of the specific runner SR is considered.

Until now, the runner matching device 1000 and the runner matching method using the same according to the embodiments of the present invention have been described.

According to the embodiments of the present invention, because a matching runner who is to have a running match with a specific runner SR is selected after a request for at least one of the matching runner who is to run together with the specific runner in real time or whose record is to be compared with that of the specific runner SR in non-real time, a distance and a course, by which the specific runner SR is to run, a specific running section, and the number of matching runners is received, the preference of the specific runner SR can be enhanced.

Further, a running match, in which minimized temporal and spatial restrictions are applied to the specific runner and the matching runner, may be provided through the specific runner matching device and the matching device of the matching runner which communicate with each other through a server.

Further, because a matching runner having a running environment that is in accordance with the reference running environment information related to the running environment including at least one of the air quality, the altitude, the temperature, and the humidity of the running route of the specific runner SR is provided, a fair and motivated running match may be provided to the specific runner SR and the matching runner.

That is, when the specific runner searches for a person who is to run together with the specific runner, the matching runner who is matched according to a running environment similarity reference can run together without having to gather physically. That is, a person in a city or a nation that is different from that of the specific runner can run together.

Further, because the running record of the specific runner SR is managed and the section in which the running ranks of the specific runner SR and the matching runner are changed is managed as a highlight section if the running match of the specific runner SR and the matching runner is ended, the running ability of the specific runner SR can be improved.

Although a situation in which the specific runner SR and the matching runner are matched in one-to-one correspondence has been described in the above-described embodiment, which will be described below, it is apparent that the specific runner SR and a plurality of matching runners who are in accordance with the request for the matching of the specific runner SR may be matched in one-to-multiple correspondence.

The runner matching device according to the embodiment of the present invention may be implemented in any form of an electronic device. For example, the runner matching device may be a smartphone, and the functions of the above-described embodiments may be implemented in a smartphone. That is, the function of at least one of the running environment collecting unit 100, the matching runner selection receiving unit 200, the runner matching unit 300, the running broadcasting unit 400, and the record managing unit 500 may be implemented by a smartphone in a software fashion. In other words, the embodiments of the present invention may be implemented by a smartphone by using applications.

Although the preferred embodiments of the present invention have been described in detail until now, the scope of the present invention is not limited to the embodiments and should be construed by the attached claims. Further, it should be understood that those skilled in the art to which the present invention pertains may variously correct and modify the present invention without departing from the scope of the present invention.

What is claimed is:

1. A runner matching device comprising:
a running environment collecting unit configured to acquire reference running environment information related to a running environment comprising at least one of an air quality, an altitude, a temperature, and a humidity of a running route of a specific runner;
a matching runner selection receiving unit configured to receive, from the specific runner, a request for selection of a matching runner who is to have a running match with the specific runner; and
a runner matching unit configured to, when a request for runner matching is made to the matching runner selection receiving unit, provide the matching runner, wherein the matching runner has a running environment that is in accordance with the reference running environment information.

2. A runner matching device comprising:
a record managing unit configured to manage a running record of a specific runner;
a matching runner selection receiving unit configured to receive, from the specific runner, a request for selection of a matching runner who is to have a running match with the specific runner; and
a runner matching unit configured to provide the matching runner, wherein the matching runner is in accordance with a running record of the specific runner.

3. The runner matching device of claim 1, wherein when providing the matching runner, the matching runner belongs to a city or a nation that is different from that of the specific runner.

4. The runner matching device of claim 1, wherein the matching runner selection receiving unit receives the selection of the matching runner from the specific runner, and receives the selection of the matching runner who is to run together in real time or receives the selection of the matching runner, whose record is to be compared with that of the specific runner in non-real time, and
wherein the runner matching unit provides the matching runner who is in accordance with the real-time or non-real-time selection of the matching runner, which is requested from the matching runner selection receiving unit.

5. The runner matching device of claim 1, wherein the request for the selection of the matching runner is made to the matching runner selection receiving unit by the specific runner, and the matching runner selection receiving unit receives information on a distance for running, and
wherein the runner matching unit provides, to the matching runner selection receiving unit, the matching runner who is in accordance with the received distance for the running.

6. The runner matching device of claim 5, wherein the request for the selection of the matching runner is made to the matching runner selection receiving unit by the specific runner, and the matching runner selection receiving unit receives information on a course for running, and
wherein the runner matching unit provides, to the matching runner selection receiving unit, the matching runner who is in accordance with the received course for the running.

7. The runner matching device of claim 1, wherein the record managing unit further manages records for running sections of the specific runner,
wherein the request for the selection of the matching runner is made to the matching runner selection receiving unit, and a request for, among the running sections, a specific running section for finding the corresponding matching runner is made to the matching runner selection receiving unit, and
wherein the runner matching unit provides, to the matching runner selection receiving unit, the matching runner who is in accordance with the record of the specific runner in the specific running section.

8. The runner matching device of claim 1, further comprising:
a running broadcasting unit configured to broadcast a running situation of the specific runner and the matching runner,
wherein the running broadcasting unit broadcasts the running situation to the specific runner in real time.

9. The runner matching device of claim 8, further comprising:
a record managing unit,
wherein the record managing unit manages a section, in which the running ranks of the specific runner and the matching runner are changed, as a highlight section, and
wherein the record managing unit provides contents on the broadcasting of the running broadcasting unit in the highlight section.

10. The runner matching device of claim 1, wherein the request for the selection of the matching runner is made to the matching runner selection receiving unit by the specific runner, and a request for the number of matching runners is made to the matching runner selection receiving unit, and
wherein the runner matching unit provides the matching runner based on the number of the matching runners.

11. A runner matching method comprising:
receiving, from the specific runner, a request for selection of a matching runner who is to have a running match with the specific runner;
acquiring reference running environment information related to a running environment comprising at least one of an air quality, an altitude, a temperature, and a humidity of a running route of a specific runner; and
providing the matching runner, wherein the matching runner has a running environment that is in accordance with the reference running environment information.

12. A runner matching method comprising:
receiving, from the specific runner, a request for selection of a matching runner who is to have a running match with the specific runner;
acquiring a running record of the specific runner; and
providing the matching runner, wherein the matching runner has a running environment that is in accordance with the running record of the specific runner.

13. The runner matching method of claim 11, wherein the receiving of the request for the selection of the matching runner comprises:
receiving a request for at least one of the matching runner who is to runner together with the specific runner in real time or whose record is to be compared with that of the specific runner in non-real time, a distance, by which the specific runner is to run, a running record of the specific runner, and the number of participants whom the specific runner desires to run with.

14. The runner matching method of claim 13, further comprising:
managing records for running sections of the specific runner,
wherein the receiving of the request for the selection of the matching runner further comprises:
receiving a request for, among the running sections provided in the managing of the records for the running sections, a specific running section for finding the corresponding matching runner is made to the matching runner selection receiving unit.

15. The runner matching method of claim 11, further comprising:
broadcasting a running situation of the specific runner and the matching runner in real time.

16. The runner matching method of claim 11, further comprising:
providing a section, in which the running ranks of the specific runner and the matching runner are changed, as a highlight section.

17. A runner matching application stored in a medium to execute operations of:
receiving, from the specific runner, a request for selection of a matching runner who is to have a running match with the specific runner;
acquiring reference running environment information related to a running environment comprising at least one of an air quality, an altitude, a temperature, and a humidity of a running route of a specific runner; and
providing the matching runner, wherein the matching runner has a running environment that is in accordance with the reference running environment information.

18. A runner matching application stored in a medium to execute operations of:
receiving, from the specific runner, a request for selection of a matching runner who is to have a running match with the specific runner;
acquiring a running record of the specific runner; and
providing the matching runner, wherein the matching runner has a running environment that is in accordance with the running record of the specific runner.
